(19) United States
(12) Patent Application Publication
(10) Pub. No.: US 2013/0007369 A1
(43) Pub. Date: Jan. 3, 2013

(54) Transparent Cache for Mobile Users

(75) Inventors: Bong J. Ko, Harrington Park, NJ (US); Vasileios Pappas, Elmsford, NY (US); Dinesh C. Verma, New Castle, NY (US)

(73) Assignee: INTERNATIONAL BUSINESS MACHINES CORPORATION, Armonk, NY (US)

(21) Appl. No.: 13/171,705

(22) Filed: Jun. 29, 2011

(51) Int. Cl. G06F 12/08

(52) U.S. Cl. 711/126; 711/E12.02

(57) ABSTRACT

A system includes a cache node operative to communicatively connect to a user device, cache data, and send requested cache data to the user device, and a first support cache node operative to communicatively connect to the cache node, cache data, and send requested cache data to the user device via the cache node.

### BACKGROUND

The present invention relates to mobile devices, and more specifically, to caching data in wireless data systems.

In wireless data systems, a wireless device is often wirelessly connected to a station that is operated by a wireless service provider. The station often includes a cache server that stores data objects from data sources such as Internet servers, websites, and other content providers. The cache server may store cached objects that may be opportunistically cached from previous user requests or cached objects that are proactively pushed from a content distribution network. The cache server minimizes the use of bandwidth in the data network and data transmission times to the user device by substituting cached objects for the requested objects and sending the substituted cached objects to the user device. The substitution is often performed by the cache server and is transparent to the user device.

### BRIEF SUMMARY

According to one embodiment of the present invention, system includes a cache node operative to communicatively connect to a user device, cache data, and send requested cache data to the user device, and a first support cache node operative to communicatively connect to the cache node, cache data, and send requested cache data to the user device via the cache node.

According to another embodiment of the present invention, a method includes receiving a request for data from a user device at a cache node, determining whether the requested data is cached in the cache node, marking the request for data with an indicator that the requested data is cached in the cache node responsive to determining that the requested data is cached in the cache node, and sending a marked request for data with the indicator that the requested data is cached in the cache node to a first support cache node.

According to another embodiment of the present invention, a method includes receiving a request for data from a cache node, determining whether the request for data is marked with the indicator that the requested data is cached in the cache node, and caching the requested data responsive to determining that the request for data is marked with the indicator that the requested data is cached in the cache node.

According to yet another embodiment of the present invention, a method includes receiving a request for an application process from a user device at a cache node, determining whether the request for the application process may be processed at the cache node, processing the request for the application process at the cache node responsive to determining that the request for the application process may be processed at the cache node, marking the request for the application process with an indicator that the requested application process is processed at the cache node responsive to determining that the requested application process may be processed at the cache node, and sending a marked request for the application process with the indicator that the requested application process is processed at the cache node to a first support cache node.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE SEVERAL VIEWS OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIGS. 1A and 1B illustrate a prior art example of a data network system.

FIGS. 2A and 2B illustrate an exemplary embodiment of a data network system.

FIG. 3 illustrates a block diagram of an exemplary method for operating the cache nodes of FIG. 2A.

FIG. 4 illustrates a block diagram of an exemplary method for operating the support cache node of FIG. 2A.

FIG. 5 illustrates a block diagram of an exemplary architecture of a system.

FIG. 6 illustrates a block diagram of an exemplary method for operating the support cache nodes of FIG. 5.

FIG. 7 illustrates a block diagram of an exemplary method for operating the cache nodes of FIGS. 2A and 5.

### DETAILED DESCRIPTION

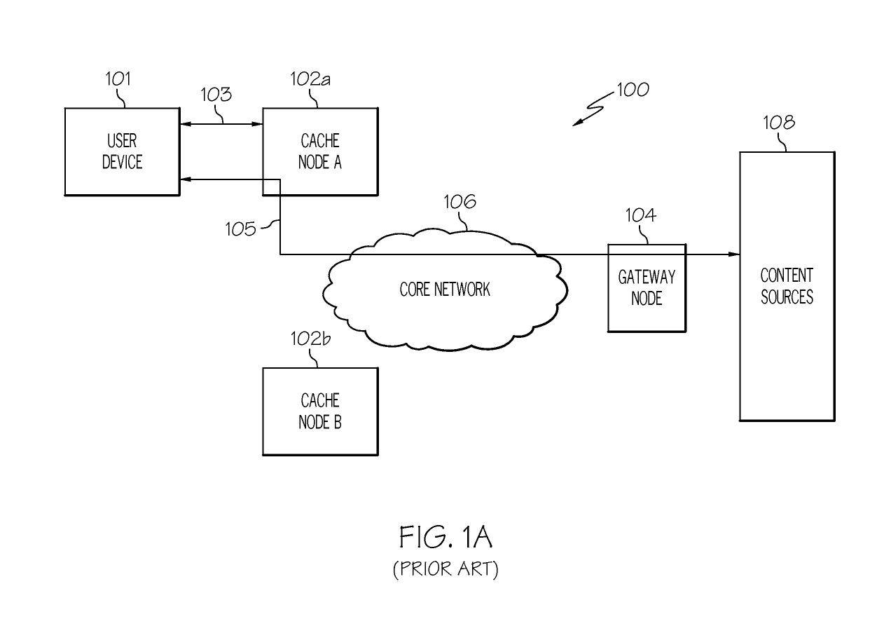

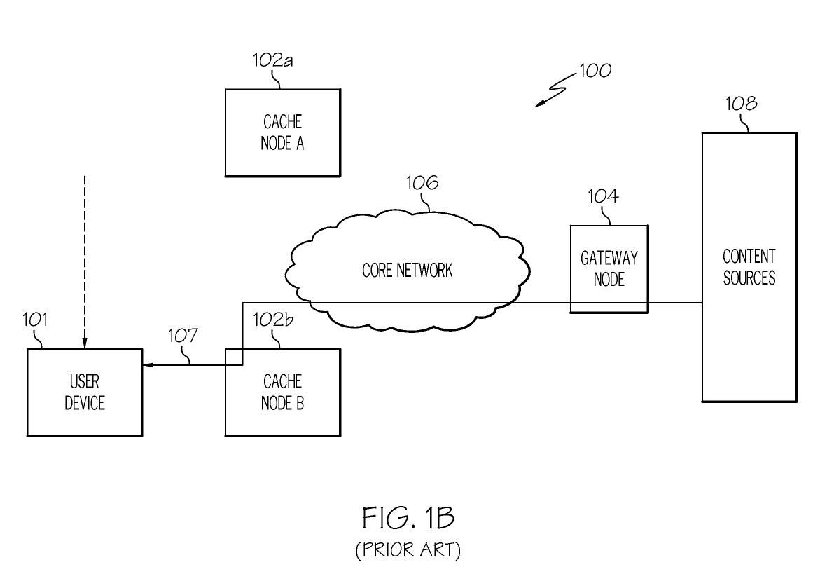

FIGS. 1A and 1B illustrate a prior art example of a data network system (system) 100. In this regard, referring to FIG. 1A the system 100 includes cache nodes (CN) A and B 102a and 102b (generally referred to as 102) that may be communicatively connected to a gateway node 104 via a network 106. The gateway node 104 and the CN 102 include, for example communications server hardware and software that may include one or more processors, memory devices, user input devices, input and output communications hardware and display devices. The gateway node 104 may communicatively connect to any number of content sources 108, for example, HyperText Markup Language (HTML) based website(s) via a network or Internet 110. The user device 101 in the illustrated embodiment is a mobile computing device, but could include any type of user device. In operation, the user device 101 is served by the CN A 102a and opens an end-to-end session such as, for example, a transmission control protocol (TCP) session so that the user device 101 may download an object via the Internet from one or more content sources 108 (the originator(s) of the data objects). If the CN A 102a does not have the appropriate data objects cached, the CN A 102a will forward the request through the network 106, the gateway node 104, and the Internet 110 to the content sources 108, which will serve the data objects to the user device 101. If the CN A 102a possesses the appropriate data objects associated with the requested data stored locally in the CN A 102a cache, the CN A 102a will serve the request for data objects locally without contacting the originator of the data objects.

In FIG. 1A, the line 103 illustrates a cached data flow path for data that is stored in the CN A 102a and sent to the user device 101, while the line 105 illustrates non-cached data flow path where data flows to the user device 101 from a content source 108. In an end-to-end session (session), the user device 101 may receive cached data and/or non-cached data. Whether the user device 101 is receiving cached data or non-cached data is transparent to the user device 101. Referring to FIG. 1B, the user device 101 has moved locations during the end-to-end session such that the wireless connection between the CN A 102a has been lost and a wireless connection between the CN B 102b has been established. (In another example, the user device 101 may remain stationary, but the wireless connection to the CN A 102a may be lost due to other factors, such as the CN A 102a experiencing a power failure. In such an example, another CN 102, for example CN B 102b may establish a connection with the user device 101.) When the wireless connection to the CN B 102b is established during the end-to-end session, the CN B 102b is not aware of the state of the session as the session was being administered by the CN A 102a. Thus, the CN B 102b will reset the session by, for example, sending a TCP reset message that will force the user device 101 to restart the content download of the data objects from the content source 108, as illustrated by the data flow path line 107. Restarting the session increases the use of network bandwidth and reduces the efficiency of the data caching scheme when a connection between a user device 101 and a cache node 102 is lost.

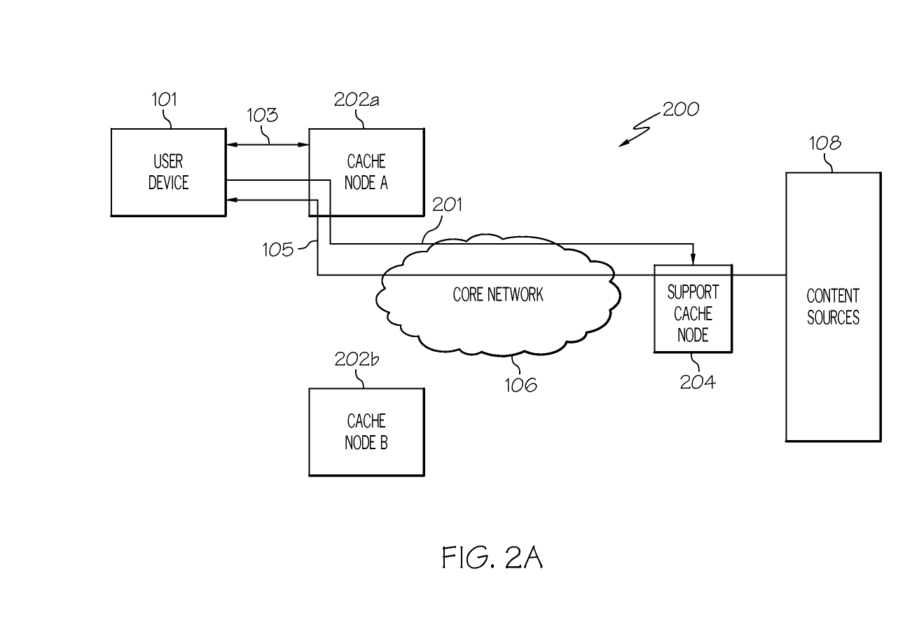

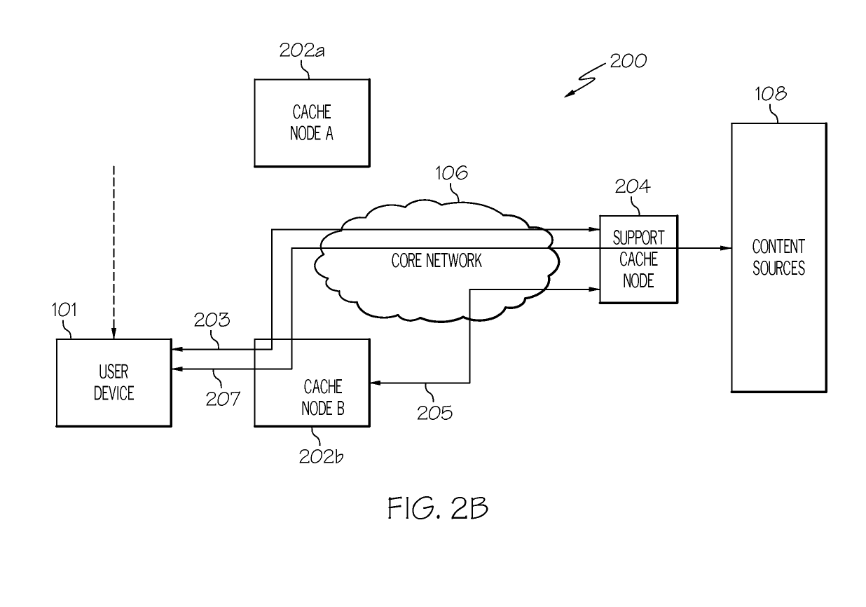

FIGS. 2A and 2B illustrate an exemplary embodiment of a data network system (system) 200 that is similar to the system 100 described above, however the gateway node 104 (of FIG. 1A) has been replaced with a support cache node (SC) 204. The support cache node 204 is similar to the gateway node 104 described above, but includes a processor and memory cache similar to the cache in the CN A and B 102a and 102b described above that is operative to cache data objects. Referring to FIG. 2A, the user device 101 has established an end-to-end session with a cache node A 202a and is receiving cached data from the CN A 202a via the data flow path 103 and may receive some data from the content sources 108 via the data flow path 105. The CNs 202 each include a processor and a memory cache. When the CN A 202a receives a request for data from the user device 101, the CN A 202a determines whether the data is cached in the CN A 202a. If the data is not cached in the CN A 202a, the CN A 202a passes the request to the content sources 108 via the flow path 105. If the data is cached in the CN A 202a, the CN A 202a serves the cached data to the user device 101, and also forwards the request to the SC 204 with an indicator that the request is being served by the cached data in the CN A 202a as shown by the data flow path 201. The indicator may include for example, a change to a bit in a field in the protocol stack above the network layer that may include, for example, general packet radio service tunneling protocol (GTP), and/or Internet protocol (IP) or a new header above the network layer. When the SC 204 receives a request from the CN A 202a, the SC 204 retrieves and catches the data and determines whether the request included the indicator that the request is being served by the cached data in the CN A 202a. If yes, the SC 204 retains the cached data locally and performs a similar data catching function as the CN A 202a however, the SC 204 retains the cached data and does not forward the data to the user device 101. The SC 204 mirrors the caching state of the CN A 202a server without forwarding the data to the user device 101.

Referring to FIG. 2B, the user device 101 has lost the connection with the CN A 202a, and has established a connection with the CN B 202b. When the connection is established between the user device 101 and the CN B 202b, the CN B 202b is unaware of the state of the session, and cannot send cached data locally stored in the CN B 202b to the user device 101. Thus, the CN B 202b sends a request for data to the content sources 108 via the SC 204 without an indicator that the CN B 202b is serving the user device 101 with cached data in the CN B 202b. The SC 204 receives the data request without the indicator and determines whether the SC 204 has cached the requested data. If not, the SC 204 forwards the data request to the content sources 108. If yes, the SC 204 serves the appropriate cached data to the user device 101 as indicated by the flow path 203. For data requests for data that is not cached in the SC 204, the data requests are sent to the content source 108 and served to the user device 101 along the flow path 207. Subsequent data requests from the user device 101 may include requests for data that is cached locally at the CN B 202b. The CN B 202b marks the data requests with an indicator that the data is being served locally by the CN B 202b to the user device 101 and forwards the indicated request to the SC 204 in a similar manner as described above along the flow path 205. The SC 204 may then mirror the cache of the CN B 202b to maintain state awareness for the sessions.

The system 200 described above allows the SC 204 to emulate the behavior of the CNs 202 without receiving explicit state information transfers assuming that the CNs 202 and the SC 204 run similar software and use pseudo-random functions that produce the same deterministic result given the same input. For example, if the transport protocol is TCP and the application protocol is HTTP than given the same TCP/HTTP packets sent by the user, both the CN 202 and the SC 204 with produce the same reply packets. This assumes that the initial TCP sequence numbers were produced by the same pseudo-random functions that take as input information common to the CN 202 and the SC 204 (e.g., using a one-way hash of the incoming TCP SYN packet, where the TCP SYN is a first packet of a TCP connection that includes a SYN flag in the TCP header). In a case where the implicit state synchronization is not possible, the CN 202 and the SC 204 may exchange protocol/application information that enables a synchronization. The exchange of protocol/application information may, for example, be accomplished by adding a new header above the TCP header that is only visible to the CN 202 and the SC 204. Such a header would be stripped from a data packet prior to the packet being sent to the user device 101 or to the content sources 108.

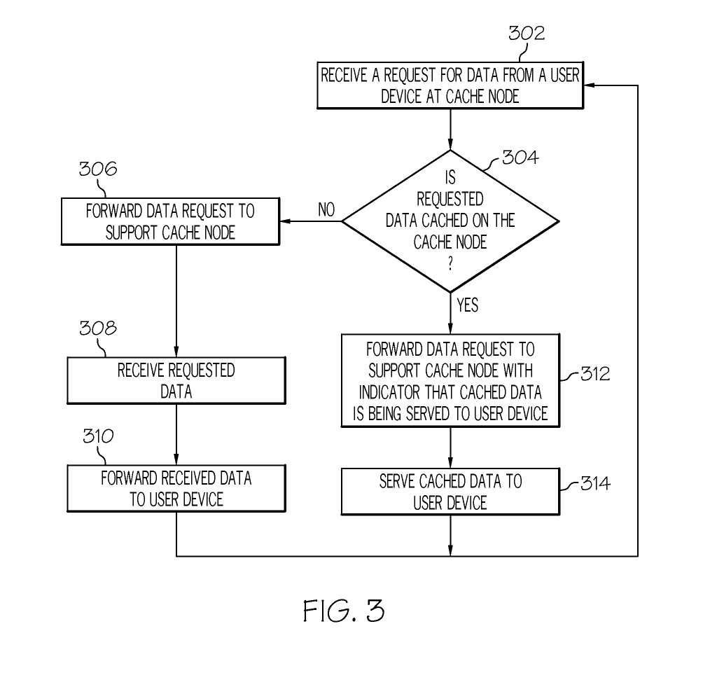

FIG. 3 illustrates a block diagram of an exemplary method for operating the CN A and B 202a and 202b (of FIG. 2A). In block 302 a request for data is received from the user device 101 at a CN 202. The CN 202 determines whether the requested data is cached on the cache node in block 304. In block 306, if the data is not cached, the data request is forwarded to the support cache node. In block 308, the requested data is received. The requested data may be received from the support cache node 204, which may have cached the data, or from the content sources 108 via the support cache node 204. The CN 202 forwards the received data to the user device 101 in block 310. If the requested data is cached on the CN 202, the data request is marked with an indicator indicating that the CN 202 is serving the cached data to the user device 101, and forwarded to the SC 204 in block 312. In block 314, the cached data is served to the user device.

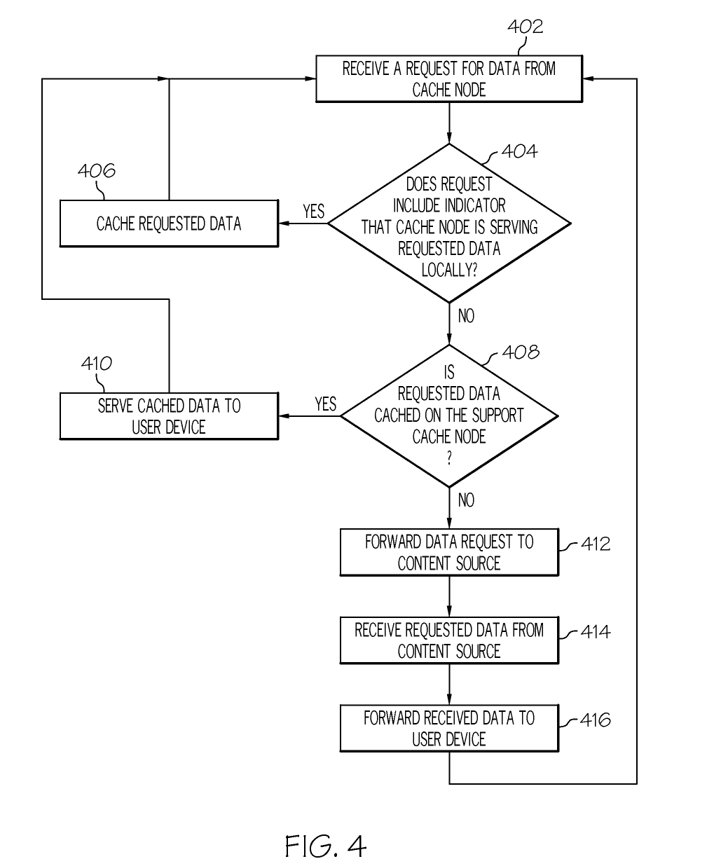

FIG. 4 illustrates a block diagram of an exemplary method for operating the support cache node 204 (of FIG. 2A). In block 402, the SC 204 receives a request for data from the user device 101 that has been forwarded by the CN 202. In block 404, the 204 determines whether the received request includes an indicator that the CN 202 is serving the data to the user device 101 with data cached at the CN 202. If yes, the SC 204 caches the requested data, but does not forward the cached data to the user device 101 via the CN 202 in block 406. If no, the SC 204 determines whether the requested data is cached on the SC 204 in block 408. If yes, in block 410, the SC 204 serves the cached data to the user device 101. If no, the SC 204 forwards the data request to the content source 108 in block 412. In block 414, the SC 204 receives the requested data from the content source 108. The received data is forwarded to the user device 101 via the CN 202 in block 416.

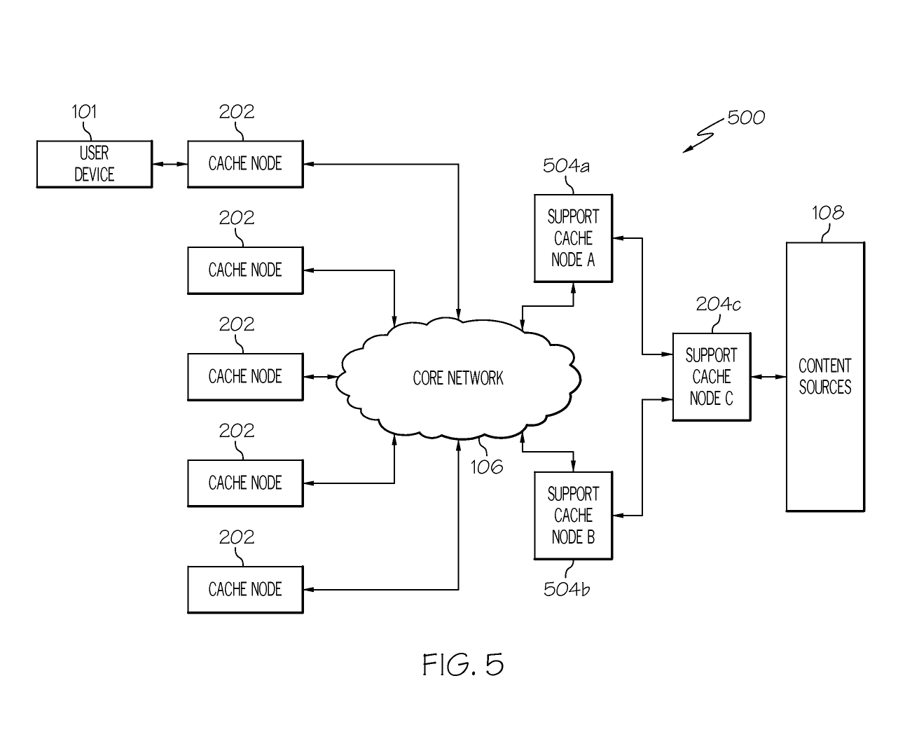

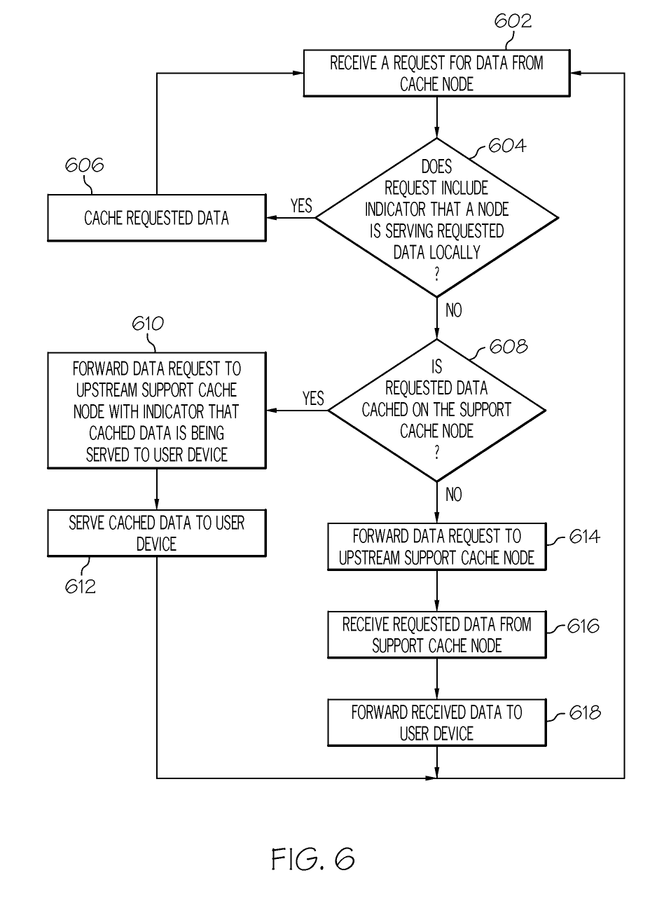

FIG. 5 illustrates a block diagram of an exemplary architecture of a system 500. The system 500 operates in a similar manner as the system 200 described above, but includes additional support cache (SC) nodes 504a, 504b, and 204c, where the SC node 204c is arranged to send and receive data from the intermediary SC nodes 504a and 504b. In the system 500, the CN 202 operate similarly to the CN 202 described above in system 200. The CN 202c operates similarly to the CN 202 node of the system 200. An exemplary method of operation of the SC nodes 502a and 502b is described below in FIG. 6. Though the exemplary embodiment of the system 500 includes five CNs 202, two intermediary SC nodes 502a and 502b, and a SC node 204c, alternate embodiments may include any number of nodes that may include any number of hierarchical levels.

FIG. 6 illustrates a block diagram of an exemplary method for operating the SC nodes 502a and 502b (of FIG. 5). In block 602, the SC 504 receives a request for data from the user device 101 that has been forwarded by the CN 202. In block 604, the 504 determines whether the received request includes an indicator that the CN 202 is serving the data to the user device 101 with data cached at the CN 202. If yes, the SC 204 caches the requested data, but does not forward the cached data to the user device 101 via the CN 202 in block 606. If no, the SC 504 determines whether the requested data is cached on the SC 504 in block 608. If yes, in block 610, the SC 504 forwards the data request to an upstream support cache node (e.g., SC 204c) with an indicator that the cached data is being served to the user device 101. In block 612, the SC 504 serves the cached data to the user device 101. If no, the SC 504 forwards the data request to the upstream SC node 204 in block 614. In block 616, the SC 504 receives the requested data from an upstream node (e.g., a content source 108 via the SC node 204). The received data is forwarded to the user device 101 via the CN 202 in block 618.

The upstream SC node 204 operates in a similar manner as the SC node 204 described above in system 200. In this regard, the SC node 204 determines whether the data request includes the indicator that the cached data is being served to the user device by a down stream node (e.g., an SC 504 or a C N 202) if the indicator is present, the SC node 204 caches the data. If the indicator is not present, the SC node 204 determines whether the SC node 204 possesses the cached data. If the SC node 204 possesses the cached data, the SC node 204 serves the data to the user device 101. If the node 204 does not possess the cached data, the SC node 204 forwards the data request to the content source 108.

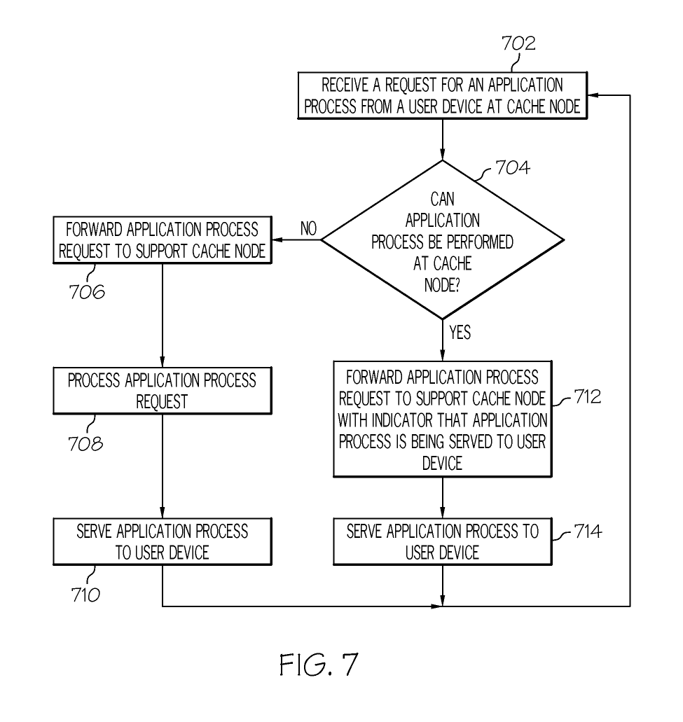

In an alternate embodiment, a similar communications method and system may be used to serve web applications or TCP applications to the user device 101. In this regard, FIG. 7 illustrates a block diagram of a method that may be performed by the system 200 (of FIG. 2) or system 500 (of FIG. 5). Referring to FIG. 7, in block 702, the CN A 202a (of FIG. 2) receives a request for an application process from the user device 101. The CN A 202a may serve an application to the user device 101 by receiving requests for data or inputs to the application, processing the requests or inputs with the application, and returning data to the user device 101. In block 704, the CN A 202a determines whether the application process may be performed at the CN A 202a. If no, the CN A 202a forwards the request to the SC 204 in block 706. The SC 204 receives the request and processes or performs requested application process in block 708. (If the SC 204 is arranged in a system similar to the system 500, the SC 204 may forward the request with an indicator that the request is being performed at the SC 204, or without the indicator if applicable, to an upstream node.) In block 710, the SC 204 serves the application process to the user device 101. If the process can be performed at the cache node A 202a (in block 704), the CN A 202a forwards the request to the SC 204 with an indication that the application process is being served by the CN A 202a to the user device 101 in block 712. In block 714, the SC 204 serves the application process to the user device 101. Thus, the system 200 and system 500 (of FIG. 5) may use a scheme similar to the caching schemes described above to serve applications to the user device 101.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon. Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks. The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The technical effects and benefits of the above described embodiments include a system and method that allows states of cached data in a wireless network to be preserved when a user device looses a wireless connection with a cache node by maintaining cached data on upstream nodes in the system and serving the user device with the cached data from an upstream node.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A system comprising:
a cache node operative to communicatively connect to a user device, cache data, and send requested cached data to the user device; and
a first support cache node operative to communicatively connect to the cache node, cached data, and send requested cache data to the user device via the cache node.

2. The system of claim 1, wherein the cache node is further operative to receive a request for data from the user device, determine whether the requested data is cached in the cache node, mark the request for data with an indicator that the requested data is cached in the cache node responsive to determining that the requested data is cached in the cache node, and send a marked request for data with the indicator that the requested data is cached in the cache node to the first support cache node.

3. The system of claim 2, wherein the cache node is further operative to send the requested data to the user device responsive to determining that the requested data is cached in the cache node.

4. The system of claim 2, wherein the cache node is further operative to send the request for data to the first support cache node responsive to determining that the requested data is not cached in the cache node.

5. The system of claim 1, wherein the first support cache node is operative to receive a request for data from the cache node, determine whether the request for data is marked with an indicator that the requested data is cached in the cache node, and cache the requested data responsive to determining that the request for data is marked with the indicator that the requested data is cached in the cache node.

6. The system of claim 5, wherein the first support cache node is further operative to determine whether the requested data is cached in the first support cache node responsive to determining that the request for data is not marked with the indicator that the requested data is cached in the cache node, and send the requested data to the user device responsive to determining that the requested data is cached in the first support cache node.

7. The system of claim 5, wherein the first support cache node is further operative to determine whether the requested data is cached in the first support cache node responsive to determining that the request for data is not marked with the indicator that the requested data is cached in the cache node, and send the request for data to a content source responsive to determining that the requested data is not cached in the first support cache node.

8. The system of claim 1, wherein the system further includes a second support cache node communicatively connected to the first support cache node, and wherein the first support cache node is operative to receive a request for data from the cache node, determine whether the request for data is marked with an indicator that the requested data is cached in the cache node, cache the requested data responsive to determining that the request for data is marked with the indicator that the requested data is cached in the cache node, and send the marked request for data with the indicator that the requested data is cached in the cache node to the second support cache node.

9. The system of claim 8, wherein the first support cache node is further operative to determine whether the requested data is cached in the first support cache node responsive to determining that the request for data is not marked with the indicator that the requested data is cached in the cache node, send the requested data to the user device responsive to determining that the requested data is cached in the first support cache node, mark the request for data with an indicator that the requested data is cached in the first support cache node responsive to determining that the requested data is cached in the first support cache node, and send a marked request for data with the indicator that the requested data is cached in the first support cache node to the second support cache node.

10. The system of claim 8, wherein the wherein the first support cache node is further operative to determine whether the requested data is cached in the first support cache node responsive to determining that the request for data is not marked with the indicator that the requested data is cached in the cache node, and send the request for data to the second support cache node responsive to determining that the requested data is not cached in the first support cache node.

11. A method comprising:
receiving a request for data from a user device at a cache node;
determining whether the requested data is cached in the cache node;
marking the request for data with an indicator that the requested data is cached in the cache node responsive to determining that the requested data is cached in the cache node; and
sending a marked request for data with the indicator that the requested data is cached in the cache node to a first support cache node.

12. The method of claim 11, wherein the method further comprises sending the requested data to the user device responsive to determining that the requested data is cached in the cache node.

13. The method of claim 12, wherein the method further comprises sending the request for data to the first support cache node responsive to determining that the requested data is not cached in the cache node.

14. The method of claim 11, wherein the method further comprises:
receiving a request for data from the cache node;
determining whether the request for data is marked with the indicator that the requested data is cached in the cache node; and
caching the requested data responsive to determining that the request for data is marked with the indicator that the requested data is cached in the cache node.

15. The method of claim 14, wherein the method further comprises:
determining whether the requested data is cached in the first support cache node responsive to determining that the request for data is not marked with the indicator that the requested data is cached in the cache node; and
sending the requested data to the user device responsive to determining that the requested data is cached in the first support cache node.

16. The method of claim 15, wherein the method further comprises:
determining whether the requested data is cached in the first support cache node responsive to determining that the request for data is not marked with the indicator that the requested data is cached in the cache node; and
sending the request for data to a content source responsive to determining that the requested data is not cached in the first support cache node.

17. The method of claim 11, wherein the method further comprises:
receiving a request for data from the cache node;
determining whether the request for data is marked with the indicator that the requested data is cached in the cache node;
caching the requested data responsive to determining that the request for data is marked with the indicator that the requested data is cached in the cache node; and
sending the marked request for data with the indicator that the requested data is cached in the cache node to a second support cache node.

18. The method of claim 17, wherein the method further comprises:
determining whether the requested data is cached in the first support cache node responsive to determining that the request for data is not marked with the indicator that the requested data is cached in the cache node;
sending the requested data to the user device responsive to determining that the requested data is cached in the first support cache node;
marking the request for data with an indicator that the requested data is cached in the first support cache node responsive to determining that the requested data is cached in the first support cache node; and
sending a marked request for data with the indicator that the requested data is cached in the first support cache node to the second support cache node.

19. The method of claim 17, wherein the method further comprises:
determining whether the requested data is cached in the first support cache node responsive to determining that the request for data is not marked with the indicator that the requested data is cached in the cache node; and
sending the request for data to the second support cache node responsive to determining that the requested data is not cached in the first support cache node.

20. A method comprising:
receiving a request for data from a cache node;
determining whether the request for data is marked with an indicator that the requested data is cached in the cache node; and
caching the requested data responsive to determining that the request for data is marked with the indicator that the requested data is cached in the cache node.

21. The method of claim 20, wherein the method further includes:
determining whether the requested data is cached in a first support cache node responsive to determining that the request for data is not marked with the indicator that the requested data is cached in the cache node; and
sending the requested data to a user device responsive to determining that the requested data is cached in the first support cache node.

22. The method of claim 21, wherein the method further includes:
determining whether the requested data is cached in the first support cache node responsive to determining that the request for data is not marked with the indicator that the requested data is cached in the cache node; and
sending the request for data to a content source responsive to determining that the requested data is not cached in the first support cache node.

23. The method of claim 21, wherein the method further includes:
sending the marked request for data with the indicator that the requested data is cached in the cache node to a second support cache node;
determining whether the requested data is cached in the first support cache node responsive to determining that the request for data is not marked with the indicator that the requested data is cached in the cache node;
sending the requested data to the user device responsive to determining that the requested data is cached in the first support cache node;
marking the request for data with an indicator that the requested data is cached in the first support cache node responsive to determining that the requested data is cached in the first support cache node;
sending a marked request for data with the indicator that the requested data is cached in the first support cache node to the second support cache node;
determining whether the requested data is cached in the first support cache node responsive to determining that the request for data is not marked with the indicator that the requested data is cached in the cache node; and
sending the request for data to the second support cache node responsive to determining that the requested data is not cached in the first support cache node.

24. A method comprising:
receiving a request for an application process from a user device at a cache node;
determining whether the request for the application process may be processed at the cache node;
processing the request for the application process at the cache node responsive to determining that the request for the application process may be processed at the cache node;
marking the request for the application process with an indicator that the requested application process is processed at the cache node responsive to determining that the requested application process may be processed at the cache node; and
sending a marked request for the application process with the indicator that the requested application process is processed at the cache node to a first support cache node.

25. The method of claim 24, wherein the method further comprises sending the request for the application process to the first support cache node responsive to determining that the request for the application process cannot be processed at the cache node.
